(19) United States
(12) Patent Application Publication
(10) Pub. No.: US 2025/0061335 A1
(43) Pub. Date: Feb. 20, 2025

(54) SYSTEMS AND METHODS FOR PROVIDING PRIVACY PROTECTION AND UTILITY PRESERVATION IN MULTI-ATTRIBUTE DATA TRANSFORMATION WITH THEORETICAL PROOFS

(71) Applicant: JPMORGAN CHASE BANK, N.A., New York, NY (US)

(72) Inventors: Yizhuo CHEN, Champaign, IL (US); Richard CHEN, Baldwin Place, NY (US); Hsiang HSU, Boston, MA (US); Shaohan HU, Yorktown Heights, NY (US); Marco PISTOIA, Amawalk, NY (US)

(21) Appl. No.: 18/449,426

(22) Filed: Aug. 14, 2023

(51) Int. Cl. G06N 3/09

(52) U.S. Cl. CPC G06N 3/09

(57) ABSTRACT

In some aspects, the techniques described herein relate to a method including: executing a machine learning model; providing a data transformation module of the machine learning model that outputs a transformed dataset; providing a sensitive attribute suppression module of the machine learning model that outputs a sensitive attribute suppression loss; providing an annotated useful attribute preservation module of the machine learning model that outputs an annotated useful attribute preservation loss; providing an unannotated useful attribute preservation module of the machine learning model that outputs an unannotated useful attribute preservation loss; combining the sensitive attribute suppression loss, the annotated useful attribute preservation loss, and the unannotated useful attribute preservation loss into a total loss; and training a neural network of the data transformation module and a neural network of the unannotated useful attribute preservation module using the total loss.

### BACKGROUND

### 1. Field of the Invention

Aspects generally relate to systems and methods for providing privacy protection and utility preservation in multi-attribute data transformation with theoretical proofs.

### 2. Description of the Related Art

Rapid advances in the fields of artificial intelligence and machine learning (AI/ML) are highly attributable to the growing richness of the datasets used in these fields. For example, studies have shown that models (e.g., machine learning models) trained on larger datasets offer better generalization and are more effectively applied to downstream applications. There are, however, ethical concerns with respect to individual privacy and personal data when using large datasets in AI/ML operations. Many, if not most, large datasets contain such sensitive data as personally identifiable information, medical information, financial information, etc. Moreover, such sensitive data and the sharing thereof may be regulated at an organizational and/or governmental level.

Empirical operations may be performed on a dataset that may show sensitive data has been effectively obfuscated (e.g., that a classifier model cannot detect sensitive data). Empirical evidence, however, does not provide a theoretical guarantee or proof that sensitive data has been effectively obfuscated. A theoretical proof may be beneficial or even required in circumstances, such as a regulatory environment, before a dataset containing sensitive data can be used in a public or shared environment. Accordingly, organizations that have collected large datasets oftentimes withhold use of these otherwise valuable and highly utilitarian data to avoid ethical or regulatory concerns with respect to leaks of sensitive data contained therein.

### SUMMARY

In some aspects, the techniques described herein relate to a method including: executing a machine learning model on at least one computer comprising a processor and a memory; providing a data transformation module of the machine learning model, wherein the data transformation module accepts a raw dataset as input to a neural network θ, and wherein the neural network θ outputs a transformed dataset; providing a sensitive attribute suppression module of the machine learning model, wherein the sensitive attribute suppression module accepts the raw dataset as input to a neural network ϕ, accepts the transformed dataset as input to a neural network ϕ′, and calculates, for each attribute of a plurality of annotated sensitive attributes S, a sensitive attribute suppression loss; providing an annotated useful attribute preservation module of the machine learning model, wherein the annotated useful attribute preservation module accepts the raw dataset as input to a neural network ψ, accepts the transformed dataset as input to a neural network ψ′, and calculates, for each attribute of a plurality of annotated useful attributes U, an annotated useful attribute preservation loss; providing an unannotated useful attribute preservation module of the machine learning model, wherein the unannotated useful attribute preservation module accepts the transformed dataset and the raw dataset as input to a neural network η, and calculates, for an unannotated useful attribute F, an unannotated useful attribute preservation loss; combining the sensitive attribute suppression loss, the annotated useful attribute preservation loss, and the unannotated useful attribute preservation loss into a total loss; and training the neural network θ and the neural network n using the total loss.

In some aspects, the techniques described herein relate to a method, wherein the neural network ϕ is trained prior to the training of the neural network θ and the neural network η using the total loss, and wherein the neural network ϕ is trained using a traditional supervised learning method.

In some aspects, the techniques described herein relate to a method, wherein neural network ϕ is fixed during the training of the neural network θ and the neural network η using the total loss.

In some aspects, the techniques described herein relate to a method, wherein the neural network ϕ′ is trained using a traditional supervised learning method at a same time as the training of the neural network θ and the neural network η using the total loss.

In some aspects, the techniques described herein relate to a method, wherein the neural network ψ is trained prior to the training of the neural network θ and the neural network η using the total loss, and wherein the neural network ψ is trained using a traditional supervised learning method.

In some aspects, the techniques described herein relate to a method, wherein neural the network ψ is fixed during the training of the neural network θ and the neural network η using the total loss.

In some aspects, the techniques described herein relate to a method, wherein the neural network ψ′ is trained using a traditional supervised learning method at a same time as the training of the neural network θ and the neural network η using the total loss.

In some aspects, the techniques described herein relate to a method, wherein the unannotated useful attribute preservation loss is an InfoNCE contrastive learning loss.

In some aspects, the techniques described herein relate to a method, wherein the sensitive attribute suppression loss is a constraint to an estimation of mutual information between each attribute of the plurality of annotated sensitive attributes S and the transformed dataset.

In some aspects, the techniques described herein relate to a method, wherein the annotated useful attribute preservation loss is a constraint to an estimation of mutual information between each attribute of a plurality of annotated useful attributes U and the transformed dataset.

In some aspects, the techniques described herein relate to a method, wherein the unannotated useful attribute preservation loss is an estimation of mutual information between the unannotated useful attribute F and the transformed dataset.

### BRIEF DESCRIPTION OF THE DRAWINGS

FIG. 1 shows a Markov Chain of random variables, in accordance with aspects.

FIG. 2 is a diagram of a model for providing privacy protection and utility preservation in multi-attribute data transformation with theoretical proofs, in accordance with aspects.

FIG. 3 shows a training system for training a neural network, in accordance with aspects.

FIG. 4 shows a training system for training a neural network, in accordance with aspects.

FIG. 5 is a logical flow for providing privacy protection and utility preservation in multi-attribute data transformation with theoretical proofs, in accordance with aspects.

FIG. 6 is a block diagram of a computing device for implementing certain aspects of the present disclosure.

### DETAILED DESCRIPTION

Aspects generally relate to systems and methods for providing privacy protection and utility preservation in multi-attribute data transformation with theoretical proofs.

Aspects may provide systems and methods that selectively suppress sensitive attributes in a dataset while preserving other useful attributes, such that the potential utility of the dataset may be fully exploited without regard to ethical privacy concerns and/or regulatory concerns. Aspects described herein may incorporate a theoretical proof of suppression/obfuscation of attributes identified as private and may incorporate such theoretical proof into a multi-attribute data transformation platform including a model or series of models such that the platform meets the theoretical proof.

Aspects may incorporate a constrained optimization problem in one or more machine learning (ML) models, where the machine learning model solves the constrained optimization problem by estimating each component of the problem. Suppression of datapoints having sensitive attributes may be converted into constraining mutual information between transformed data and the sensitive attributes. Output of a data transformation ML model may be transformed data X′. Input to each of a sensitive attribute suppression ML model, an annotated useful attribute preservation ML model, and an unannotated useful attribute preservation model may be X′. Output from each of a sensitive attribute suppression ML model, an annotated useful attribute preservation ML model, and an unannotated useful attribute preservation model may be a loss (i.e., output of a loss function). A data transformation ML model may then be iteratively trained using the loss output from the associated models.

While the term “sensitive,” referring to data, attributes, etc., is used herein to denote data and/or attributes annotated for obfuscation, it is contemplated that any annotated datapoints may be selected for obfuscation, and that “sensitive” data such as personal, medical, financial, and other non-public data is used herein only as an exemplary use case for obfuscation.

In accordance with aspects, a problem definition of an optimization problem may consider a multi-label dataset composed of raw data X, a set of M sensitive attributes S=(S₁, S₂, . . . , S_{M}), a set of N annotated useful attributes U=(U₁, U₂, . . . , U_{N}), and a set of unannotated useful attributes (i.e., generic features) F. While direct access to the joint distribution of P(X, U, S, F), may not be possible, a set of data points sampled from P(X, U, S) in the dataset may be obtained. Accordingly, an optimal data transformation P_{θ}(X′|X) that is parameterized by θ may be sought by solving the constrained optimization problem:

$${max}_{θ , P ( X , F )} I ( {X}^{′} ; F )$$

$$s . t . I ( {X}^{′} ; {S}_{i} ) \leq {m}_{i}$$

$$I ( {X}^{′} ; {U}_{j} ) \geq {n}_{j}$$

where i∈1 . . . . M, and j∈1 . . . . N, such that that when the transformed dataset X′ is released, at least nⱼ bits of information is preserved for Uⱼ in X′, at most mᵢ bits of information is released for Sᵢ in X′, and the information preserved for F in X′ is maximized when the most informative F is considered (referred to herein as the “optimization problem” or the “constrained optimization problem”).

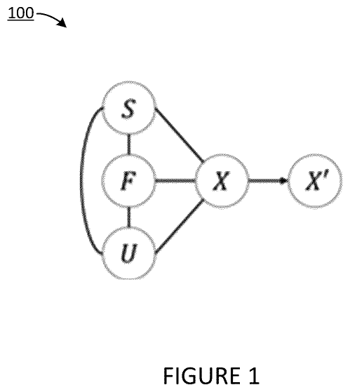

FIG. 1 shows a Markov Chain of random variables, in accordance with aspects. Markov chain 100, as depicted in FIG. 1, is of U, S, F, X, X′ and corresponds to the optimization problem definition, above.

In accordance with aspects, in solving for the optimization problem, mᵢ and nⱼ may be purposefully chosen. For instance, mᵢ and nⱼ may be chosen with the range mᵢ≥0 and nⱼ≤H(Uⱼ). These ranges for values of mᵢ and nⱼ may be proven in view of I(X′; Sᵢ)≥0 and I(X′; Uⱼ)≤H(Uⱼ). Moreover, aspects may show that ranges of mᵢ and nⱼ are also mutually constrained, as described in more detail, herein.

In accordance with aspects, given the optimization problem, and the corresponding Markov chain (as depicted in FIG. 1), there is theoretically no solution to the optimization problem, unless for any pair of (mᵢ, nⱼ), i∈1 . . . . M, j∈1 . . . . N, the pair satisfies the following equation:

$${n}_{j} \leq {m}_{i} + I ( X ; {U}_{j} \vert {S}_{i} ) .$$

A proof of this theory may be written as: for any i∈1 . . . . M, and j∈1 . . . . N, suppose both I(X′; Sᵢ)≤mᵢ and hold, then the result may be:

$$\begin{matrix}{m}_{i} + I ( X ; {U}_{j} \vert {S}_{i} ) \geq I ( {X}^{′} ; {S}_{i} ) + I ( X ; {U}_{j} \vert {S}_{i} ) \\ = I ( {X}^{′} ; {S}_{i} ) + I ( {X}^{′} , X ; {U}_{j} \vert {S}_{i} ) \\ = I ( {X}^{′} ; {U}_{j} , {S}_{i} ) - I ( {X}^{′} ; {U}_{j} \vert {S}_{i} ) + I ( {X}^{′} , X ; {U}_{j} \vert {S}_{i} ) \\ = I ( {X}^{′} ; {U}_{j} , {S}_{i} ) + I ( X ; {U}_{j} \vert {X}^{′} , {S}_{i} ) \\ = I ( {X}^{′} ; {U}_{j} ) + I ( {X}^{′} ; {S}_{i} \vert {U}_{j} ) + I ( X ; {U}_{j} \vert {X}^{′} , {S}_{i} ) \\ \geq I ( {X}^{′} ; {U}_{j} ) \\ \geq {n}_{j}\end{matrix}$$

Notably, I(X; Uⱼ|Sᵢ) is not dependent on the parameter of the model and may be calculated prior to training the model.

In accordance with aspects, neither the joint distribution P(X, F), nor any samples from it are available. Accordingly, aspects may seek to maximize the I(X′; F) w.r.t. both P(X, F) and θ, such that the most informative possible F may be considered and X′ may contain the most information for F. It may be then shown

$${max}_{P ( X , F )} I ( {X}^{′} ; F ) = I ( {X}^{′} ; X ) ,$$

Aspects may theorize as follows: for random variables X, X′, F following the Markov Chain as shown in FIG. 1,

$${max}_{P ( X , F )} I ( {X}^{′} ; F ) = I ( {X}^{′} ; X ) .$$

A proof of this theory may be according to Data Processing Inequality and may be:

$$I ( {X}^{′} ; X ) - I ( {X}^{′} ; F ) = I ( {X}^{′} ; X \vert F ) \geq 0.$$

Therefore, as a result I(X′; X)≥I(X′; F). Moreover, when P(X, F) is chosen such that H(X|F)=0, a further result is I(X′; X|F)=0. Consequently, I(X′; X)=I(X′; F). In an exemplary aspect, F=X may be chosen to illustrate the above. Accordingly, the optimization goal may be expressed as max_{θ} I(X′; X).

In accordance with aspects, bounds for the optimization goal may be derived as:

$${n}_{j} \leq I ( {X}^{′} ; X ) \leq H ( X \vert {S}_{i} ) + {m}_{i} .$$

A corresponding proof may be written, according to Data Processing Inequality, as:

$${n}_{j} \leq I ( {U}_{j} ; {X}^{′} ) \leq I ( {X}^{′} ; X ) .$$

The corresponding proof may also include:

$$I ( {X}^{′} ; X ) = H ( {X}^{′} \vert X ) = H ( X {\hat{}}^{′} ) - H ( X {\hat{}}^{′} \vert X , S\_i ) \leq H ( X {\hat{}}^{′} ) - H ( X {\hat{}}^{′} \vert X , S\_i ) + H ( X \vert X {\hat{}}^{′} , S\_i ) = H ( {X}^{′} ) + H ( X \vert {S}_{i} ) - H ( {X}^{′} \vert {S}_{i} ) = I ( {X}^{′} ; {S}_{i} ) + H ( X \vert {S}_{i} ) \leq H ( X \vert {S}_{i} ) + {m}_{i}$$

In accordance with aspects, models may be structured according to a data-driven implementation. With respect to data transformation, P_{θ}(X′|X) may be parameterized as a neural network as X′=g_{θ} (X, a), where a is a noise variable serving as a source of randomness for X′. In aspects, a may be sampled from a unit Gaussian distribution.

With respect to sensitive attribute suppression, the constraint I(X′; Sᵢ)≤mᵢ may be reformulated as:

$$I ( X ; {S}_{i} ) - {m}_{i} \leq I ( X ; {S}_{i} ) - I ( {X}^{′} ; {S}_{i} ) = {E}_{P ( X , {S}_{i} ) {P}_{θ} ( {X}^{′} \vert X )} [ log \frac{P ( {S}_{i} \vert X )}{P ( {S}_{i} \vert {X}^{′} )} ] = {E}_{P ( X ) {P}_{θ} ( {X}^{′} \vert X )} [ KL ( P ( {S}_{i} \vert X ) ‖ P ( {S}_{i} \vert {X}^{′} ) ) ] .$$

Both P(Sᵢ|X) and P(Sᵢ|X′) are not tractable but may be approximated with neural networks respectively as P_{ϕ}(Sᵢ|X) and P_{ϕ′}(Sᵢ|X′). Neural networks ϕ and ϕ′ may be trained using a traditional supervised learning method such as:

$$ϕ = arg {min}_{ϕ} {𝔼}_{P ( {S}_{i} , X )} [ - log ( {P}_{ϕ} ( {S}_{i} \vert X ) ) ] , and$$

$${ϕ}^{′} = arg {min}_{{ϕ}^{′}} {𝔼}_{P ( {S}_{i} , X ) {P}_{θ} ( {X}^{′} \vert X )} [ - log ( {P}_{{ϕ}^{′}} ( {S}_{i} \vert {X}^{′} ) ) ] .$$

Aspects may solve the constrained optimization problem (as defined, above) using a combination of linear and quadratic penalty method. Therefore, the constraint I(X′; Sᵢ)≤mᵢ may be converted into the following continuous loss function such that the model may be learned using gradient descent:

$${d}_{S , i} = min ( {E}_{P ( X ) {P}_{θ} ( {X}^{′} \vert X )} [ KL ( P ( {S}_{i} \vert X ) ‖ P ( {S}_{i} \vert {X}^{′} ) ) ] + {m}_{i} - I ( X ; {S}_{i} ) , 0 )$$

$${L}_{S , i} = {d}_{S , i}^{2} + \vert {d}_{S , i} \vert .$$

With respect to annotated useful attribute preservation, the constraint I(X′; Uⱼ)≥nⱼ may be reformulated as:

$$I ( X ; {U}_{j} ) - {n}_{j} \geq I ( X ; {U}_{j} ) - I ( {X}^{′} ; {U}_{j} ) = {𝔼}_{P ( X , {U}_{j} ) {P}_{θ} ( {X}^{′} \vert X )} [ log \frac{P ( {U}_{j} \vert X )}{P ( {U}_{j} \vert {X}^{′} )} ] = {𝔼}_{P ( X ) {P}_{θ} ( {X}^{′} \vert X )} [ KL ( P ( {U}_{j} \vert X ) \vert \vert ( P ( {U}_{j} \vert {X}^{′} ) ) ]$$

(referred to herein as the “useful attribute preservation constraint”), where both P(Uⱼ|X) and P(Uⱼ|X′) are not tractable but may be approximated with neural networks respectively as P_{ψ}(Uⱼ|X) and P_{ψ′}(Uⱼ|X′).

Similar to training a neural network for sensitive attribute suppression, as discussed above, neural networks ψ and ψ′ may be trained using a traditional supervised learning method such as:

$$ψ = arg {min}_{ψ} {𝔼}_{P ( {U}_{j} , X )} [ - log ( {P}_{ψ} ( {U}_{j} \vert X ) ) ] , and$$

$${ψ}^{′} = arg {min}_{{ψ}^{′}} {𝔼}_{P ( {U}_{j} , X ) {P}_{θ} ( {X}^{′} \vert X )} [ - log ( {P}_{{ψ}^{′}} ( {U}_{j} \vert {X}^{′} ) ) ] ,$$

where ψ′ may be trained jointly with θ, and ψ may be pretrained once before training the other parameters, because v is not dependent on the value of any other parameter. Moreover, in accordance with aspects, it may be desirable to ensure that X and X′ are kept in the same space, such that models pretrained on X may still achieve acceptable performance on X′ without further fine-tuning. Accordingly, aspects may use ψ in the place of ψ′. That is, aspects may use the same parameter ψ for both P_{ψ}(Uⱼ|X) and P_{ψ}(Uⱼ|X′).

In accordance with aspects, it may be theorized that replacing v′ with ψ does not violate the constraints of the useful attribute preservation constraint as follows: for random variables X, X′, U following the Markov Chain as shown in FIG. 1, and any probability distribution Q,

$${𝔼}_{P ( X , {X}^{′} )} [ KL ( P ( U \vert X ) ‖ Q ( U \vert {X}^{′} ) ) ] \geq {𝔼}_{P ( X , {X}^{′} )} [ KL ( P ( U \vert X ) ‖ P ( U \vert {X}^{′} ) ) ] .$$

A proof of the above theory may be written as:

$${𝔼}_{P ( X , {X}^{′} )} [ KL ( P ( U \vert X ) ‖ Q ( U \vert {X}^{′} ) ) ] - {𝔼}_{P ( X , {X}^{′} )} [ KL ( P ( U \vert X ) ‖ P ( U \vert {X}^{′} ) ) ] = {𝔼}_{P ( X , {X}^{′} , U )} [ log \frac{P ( U \vert {X}^{′} )}{Q ( U \vert {X}^{′} )} ] = KL ( P ( U \vert {X}^{′} ) ‖ Q ( U \vert {X}^{′} ) ) \geq 0.$$

In accordance with aspects, when ψ is optimized using the supervised learning method noted, above, P_{ψ}(Uⱼ|X′) is no longer an approximation to P(Uⱼ|X′). Instead, P_{ψ}(Uⱼ|X′) approximates P_{U}_{ⱼ}_{|X}(Uⱼ|X′). Accordingly, by replacing P(Uⱼ|X′) with P_{U}_{ⱼ}_{|X}(Uⱼ|X′) in the useful attribute preservation constraint, and adopting the above-stated theory with respect to replacing ψ′ with ψ, it may be shown that the original constraint still holds true as follows:

$$I ( X ; {U}_{j} ) - {n}_{j} \geq {𝔼}_{P ( X ) {P}_{θ} ( {X}^{′} \vert X )} [ KL ( P ( {U}_{j} \vert X ) ‖ {P}_{{U}_{j} \vert X} ( {U}_{j} \vert {X}^{′} ) ) ] \geq {𝔼}_{P ( X ) {P}_{θ} ( {X}^{′} , X )} [ KL ( P ( {U}_{j} \vert X ) ‖ P ( {U}_{j} \vert {X}^{′} ) ) ] .$$

Summarizing the derivation above, the constraint I(X′; Uⱼ)≥nⱼ may be converted into the following loss function using a combination of linear and quadratic penalty method:

$${d}_{U , j} = max ( {E}_{P ( X ) {P}_{θ} ( {X}^{′} , X )} [ KL ( {P}_{ψ} ( {U}_{j} \vert X ) ‖ {P}_{ψ} ( {U}_{j} \vert {X}^{′} ) ) ] + {n}_{j} - I ( X ; {U}_{j} ) , 0 )$$

$${L}_{U , j} = {d}_{U , j}^{2} + \vert {d}_{U , j} \vert .$$

In accordance with aspects, with respect to unannotated useful attributes preservation, since both X and X′ may be high dimensional, it may not be possible to approximate I(X′; X) using the methods discussed, above. Instead, aspects may approximate I(X′; X) using the negative InfoNCE contrastive learning loss function:

$$I ( {X}^{′} ; X ) \approx - {L}_{F} := {𝔼}_{X \sim P ( X )} {𝔼}_{{X}_{P}^{′} \sim {P}_{θ} ( {X}^{′} , X )} {𝔼}_{{X}_{n}^{′ ( K - 1 )} \sim {P}_{θ} ( {X}^{′} )} [ log \frac{{f}_{η} ( X , {X}_{P}^{′} )}{\begin{matrix}{f}_{η} ( X , {X}_{P}^{′} ) + \\ {\sum }_{{X}_{n}^{′} ∈ {X}_{n}^{′ ( K )}} {f}_{η} ( X , {X}_{P}^{′} )\end{matrix}} ] + log K ,$$

where X, X′_{P}, X′ₙ are the anchor, the positive sample and the negative samples, respectively. K is the number of samples including 1 positive sample and K−1 negative samples. ƒ_{η} is defined in the same way as SimCLR, which may be written as:

$${f}_{η} ( X , {X}^{′} ) = {e}^{cos ( {h}_{η} ( X ) , {h}_{η} ( {X}^{′} ) ) / τ} ,$$

where τ is the temperature hyper-parameter and h_{η} is a neural network trained jointly with θ. The symmetric definition of ƒ_{η} can ensure that X and X′ are in the same space. Notably, L_{F} is not identical to SimCLR loss, because negative samples from P(X) are not sampled.

Similarly, we can define another InfoNCE loss anchored on X′ as:

$$I ( {X}^{′} ; X ) \approx - {L}_{F}^{′} := {𝔼}_{X \sim P ( X )} {𝔼}_{{X}^{′} \sim {P}_{θ} ( {X}^{′} \vert {X}_{P} )} {𝔼}_{{X}_{n}^{( K - 1 )} \sim P ( X )} [ log \frac{{f}_{η} ( {X}_{P} , {X}^{′} )}{\begin{matrix}{f}_{η} ( {X}_{P} , {X}^{′} ) + \\ {\sum }_{{X}_{n} ∈ {X}_{n}^{( K )}} {f}_{η} ( {X}_{n} , {X}^{′} )\end{matrix}} ] + log K .$$

Aspects may use either or both of the two learning loss functions described above.

In accordance with aspects, the original constrained optimization problem may be converted into the following final-loss optimization problem:

$${min}_{θ , η} {L}_{total} = \frac{{L}_{F} + {L}_{F}^{′}}{2} + λ ( {\sum }_{i} {L}_{S , i} + {\sum }_{j} {L}_{U , j} ) .$$

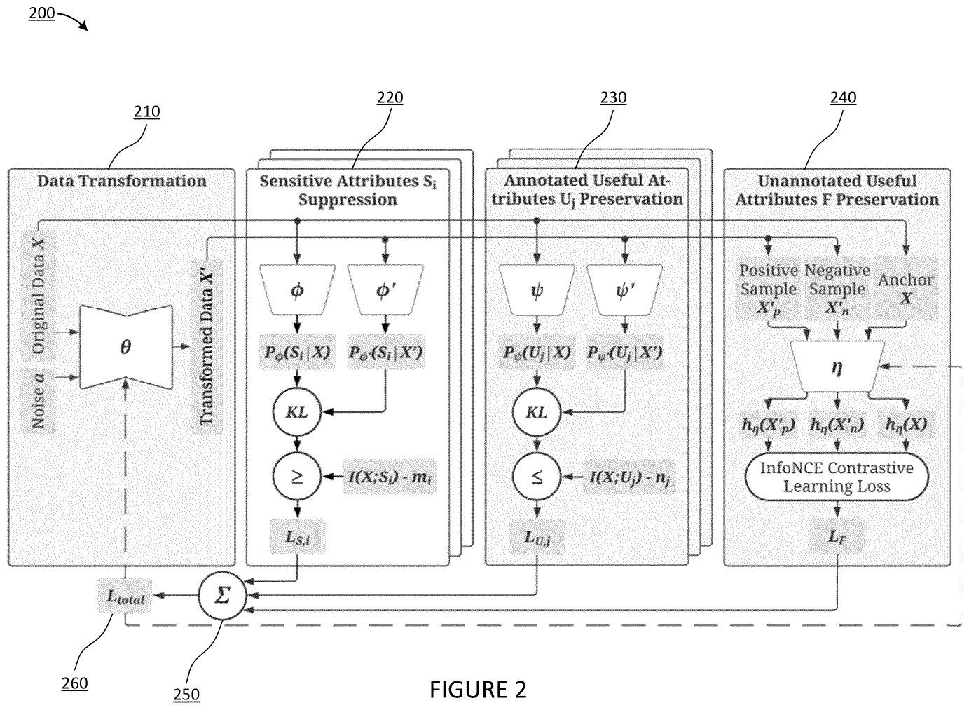

FIG. 2 is a diagram of a model for providing privacy protection and utility preservation in multi-attribute data transformation with theoretical proofs, in accordance with aspects. Model system 200 includes data transformation module 210, sensitive attribute suppression module 220, annotated useful attribute preservation module 230, unannotated useful attribute preservation module 240. Model system 200 additionally depicts summation 250 and total loss 260.

In accordance with aspects, data transformation module 210 includes neural network θ. Neural network θ may receive, as input, original or raw dataset and additional noise and may output a transformed dataset. Sensitive attribute suppression module 220 may accept the raw dataset and transformed data set that is output by data transformation module 210 as input to neural networks ϕ and ϕ′ respectively, which are included in sensitive attribute suppression module 220. Sensitive attribute suppression module 220 may calculate, for each attribute of a plurality of annotated sensitive attributes S, a sensitive attribute suppression loss as described in more detail, herein. Sensitive attribute suppression module 220 may provide the calculated sensitive attribute suppression loss as output.

Annotated useful attribute preservation module 230 may accept the raw dataset and the transformed dataset as input to neural networks ψ and ψ′ respectively, which are included in annotated useful attribute preservation module 230. Annotated useful attribute preservation module 230 may calculate, for each attribute of a plurality of annotated useful attributes U, an annotated useful attribute preservation loss. Annotated useful attribute preservation module 230 may provide the useful attribute preservation loss as output.

Unannotated useful attribute preservation module 240 may accept the transformed dataset and the raw dataset as input to a neural network η, which is included in unannotated useful attribute preservation module 240. Unannotated useful attribute preservation module 240 may calculate, for an unannotated useful attribute F, an unannotated useful attribute preservation loss. Unannotated useful attribute preservation module 240 may provide the unannotated useful attribute preservation loss as output.

Summation 250 represents the sum or totaling of each of the calculated sensitive attribute suppression loss, the annotated useful attribute preservation loss, and the unannotated useful attribute preservation loss into total loss 260. Total loss 260 may be used to train neural network θ of data transformation module 210. Total loss 260 may further be used to train neural network η of unannotated useful attribute preservation module 240. In accordance with aspects, “KL” in sensitive attribute suppression module 220 and annotated useful attribute preservation module 230 denotes the Kullback-Leibler divergence. Additionally, “≥” and “≤” operations depicted in FIG. 2 may be relaxed using Penalty Method. The dashed line in FIG. 2 represents minimization.

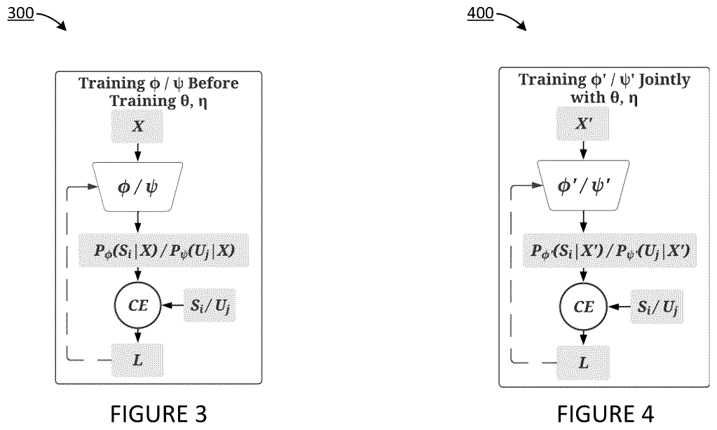

FIG. 3 shows a training system for training a neural network, in accordance with aspects. Training system 300 depicts training of a neural network ϕ or ψ using a traditional supervised learning method. Training of neural network ϕ or ψ may be performed prior to training of the neural network θ, and neural network η, as described in more detail, herein. “CE” in training system 300 denotes cross-entropy. The dashed line in FIG. 3 represents minimization.

FIG. 4 shows a training system for training a neural network, in accordance with aspects. Training system 400 depicts training of a neural network ϕ′ or ψ′ using a traditional supervised learning method (as described in more detail, herein). Training of neural network ϕ′ or ψ′ may be performed at the same time as training of the neural network θ and the neural network η using the total loss, as described in more detail, herein. “CE” in training system 400 denotes cross-entropy. The dashed line in FIG. 4 represents minimization.

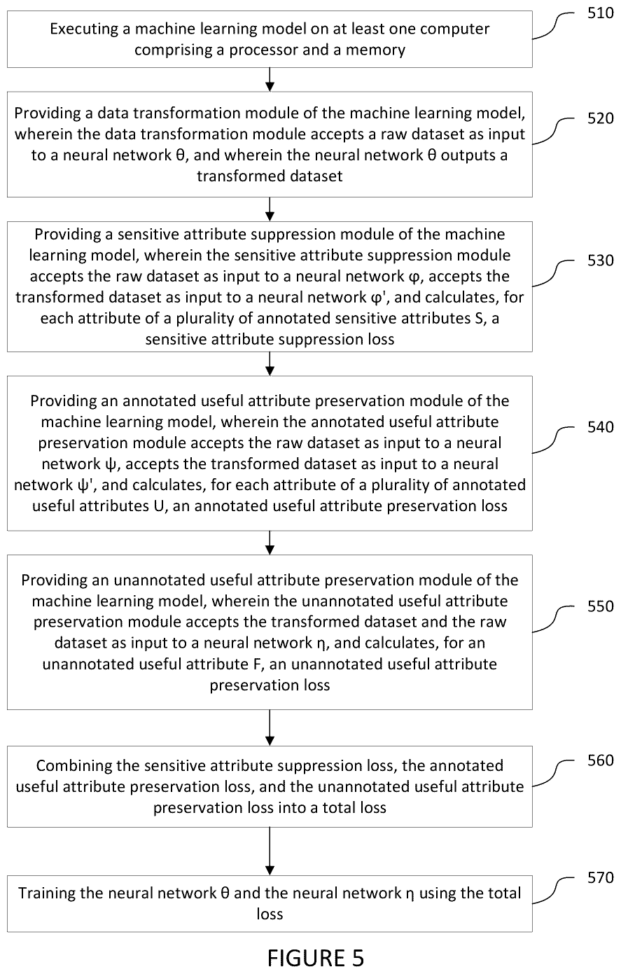

FIG. 5 is a logical flow for providing privacy protection and utility preservation in multi-attribute data transformation with theoretical proofs, in accordance with aspects.

Step 510 includes providing a machine learning model that executes on at least one computer comprising a memory and a processor.

Step 520 includes providing a data transformation module of the machine learning model, wherein the data transformation module accepts a raw dataset as input to a neural network θ, and wherein the neural network θ outputs a transformed dataset.

Step 530 includes providing a sensitive attribute suppression module of the machine learning model, wherein the sensitive attribute suppression module accepts the raw dataset as input to a neural network ϕ, accepts the transformed dataset as input to a neural network ϕ′, and calculates, for each attribute of a plurality of annotated sensitive attributes S, a sensitive attribute suppression loss.

Step 540 includes providing an annotated useful attribute preservation module of the machine learning model, wherein the annotated useful attribute preservation module accepts the raw dataset as input to a neural network ψ, accepts the transformed dataset as input to a neural network ψ′, and calculates, for each attribute of a plurality of annotated useful attributes U, an annotated useful attribute preservation loss.

Step 550 includes providing an unannotated useful attribute preservation module of the machine learning model, wherein the unannotated useful attribute preservation module accepts the transformed dataset and the raw dataset as input to a neural network η, and calculates, for an unannotated useful attribute F, an unannotated useful attribute preservation loss.

Step 560 includes combining the sensitive attribute suppression loss, the annotated useful attribute preservation loss, and the unannotated useful attribute preservation loss into a total loss.

Step 570 includes training the neural network θ and the neural network η using the total loss.

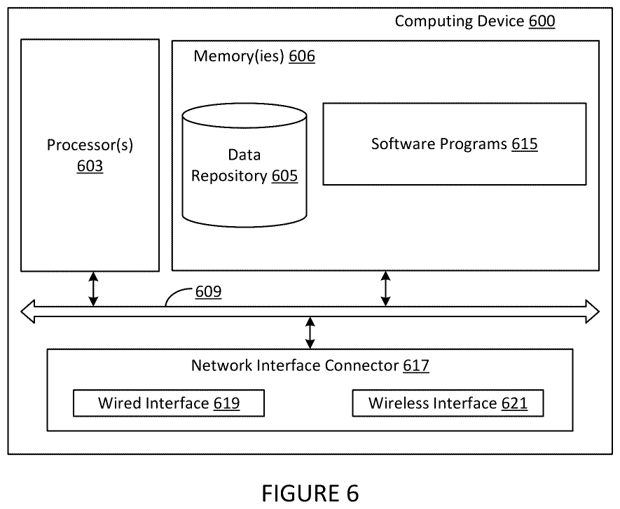

FIG. 6 is a block diagram of a computing device for implementing certain aspects of the present disclosure. FIG. 6 depicts exemplary computing device 600. Computing device 600 may represent hardware that executes the logic that drives the various system components described herein. For example, system components such as a machine learning model and the various modules including neural networks thereof, a ML model training processes as described herein, an interface, various database engines and database servers, and other computer applications and logic may include, and/or execute on, components and configurations like, or similar to, computing device 600.

Computing device 600 includes a processor 603 coupled to a memory 606. Memory 606 may include volatile memory and/or persistent memory. The processor 603 executes computer-executable program code stored in memory 606, such as software programs 615. Software programs 615 may include one or more of the logical steps disclosed herein as a programmatic instruction, which can be executed by processor 603. Memory 606 may also include data repository 605, which may be nonvolatile memory for data persistence. The processor 603 and the memory 606 may be coupled by a bus 609. In some examples, the bus 609 may also be coupled to one or more network interface connectors 617, such as wired network interface 619, and/or wireless network interface 621. Computing device 600 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” a “computer,” an “electronic device,” a “mobile device,” etc. These may be a computer, a computer server, a host machine, etc. As used herein, the term “processing machine,” “computing device, “computer,” “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above, including any logical stops or logical flows described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
executing a machine learning model on at least one computer comprising a processor and a memory;
providing a data transformation module of the machine learning model, wherein the data transformation module accepts a raw dataset as input to a neural network θ, and wherein the neural network θ outputs a transformed dataset;
providing a sensitive attribute suppression module of the machine learning model, wherein the sensitive attribute suppression module accepts the raw dataset as input to a neural network ϕ, accepts the transformed dataset as input to a neural network ϕ′, and calculates, for each attribute of a plurality of annotated sensitive attributes S, a sensitive attribute suppression loss;
providing an annotated useful attribute preservation module of the machine learning model, wherein the annotated useful attribute preservation module accepts d the raw dataset as input to a neural network ψ, accepts the transformed dataset as input to a neural network ψ′, and calculates, for each attribute of a plurality of annotated useful attributes U, an annotated useful attribute preservation loss;
providing an unannotated useful attribute preservation module of the machine learning model, wherein the unannotated useful attribute preservation module accepts the transformed dataset and the raw dataset as input to a neural network η, and calculates, for an unannotated useful attribute F, an unannotated useful attribute preservation loss;
combining the sensitive attribute suppression loss, the annotated useful attribute preservation loss, and the unannotated useful attribute preservation loss into a total loss; and
training the neural network θ and the neural network η using the total loss.

2. The method of claim 1, wherein the neural network ϕ is trained prior to the training of the neural network θ and the neural network η using the total loss, and wherein the neural network ϕ is trained using a traditional supervised learning method.

3. The method of claim 2, wherein neural network ϕ is fixed during the training of the neural network θ and the neural network η using the total loss.

4. The method of claim 1, wherein the neural network ϕ′ is trained using a traditional supervised learning method at a same time as the training of the neural network θ and the neural network η using the total loss.

5. The method of claim 1, wherein the neural network ψ is trained prior to the training of the neural network θ and the neural network η using the total loss, and wherein the neural network ψ is trained using a traditional supervised learning method.

6. The method of claim 5, wherein neural the network ψ is fixed during the training of the neural network θ and the neural network η using the total loss.

7. The method of claim 1, wherein the neural network ψ′ is trained using a traditional supervised learning method at a same time as the training of the neural network θ and the neural network η using the total loss.

8. The method of claim 1, wherein the unannotated useful attribute preservation loss is an InfoNCE contrastive learning loss.

9. The method of claim 1, wherein the sensitive attribute suppression loss is a constraint to an estimation of mutual information between each attribute of the plurality of annotated sensitive attributes S and the transformed dataset.

10. The method of claim 1, wherein the annotated useful attribute preservation loss is a constraint to an estimation of mutual information between each attribute of a plurality of annotated useful attributes U and the transformed dataset.

11. The method of claim 1, wherein the unannotated useful attribute preservation loss is an estimation of mutual information between the unannotated useful attribute F and the transformed dataset.

12. A system comprising at least one computer including a processor and a memory, wherein the at least one computer is configured to execute a machine learning model, and wherein the machine learning model is configured to:
provide a data transformation module of the machine learning model, wherein the data transformation module accepts a raw dataset as input to a neural network θ, and wherein the neural network θ outputs a transformed dataset;
provide a sensitive attribute suppression module of the machine learning model, wherein the sensitive attribute suppression module accepts the raw dataset as input to a neural network ϕ, accepts the transformed dataset as input to a neural network ϕ′, and calculates, for each attribute of a plurality of annotated sensitive attributes S, a sensitive attribute suppression loss;
provide an annotated useful attribute preservation module of the machine learning model, wherein the annotated useful attribute preservation module accepts the raw dataset as input to a neural network ψ, accepts the transformed dataset as input to a neural network ψ′, and calculates, for each attribute of a plurality of annotated useful attributes U, an annotated useful attribute preservation loss;
provide an unannotated useful attribute preservation module of the machine learning model, wherein the unannotated useful attribute preservation module accepts the transformed dataset and the raw dataset as input to a neural network η, and calculates, for an unannotated useful attribute F, an unannotated useful attribute preservation loss;
combine the sensitive attribute suppression loss, the annotated useful attribute preservation loss, and the unannotated useful attribute preservation loss into a total loss; and
train the neural network θ and the neural network η using the total loss.

13. The system of claim 12, wherein the neural network ϕ is trained prior to the training of the neural network θ and neural network η using the total loss, and wherein the neural network ϕ is trained using a traditional supervised learning method.

14. The system of claim 13, wherein neural network ϕ is fixed during the training of the neural network θ and the neural network η using the total loss.

15. The system of claim 12, wherein the neural network ϕ′ is trained using a traditional supervised learning method at a same time as the training of the neural network θ and the neural network η using the total loss.

16. The system of claim 12, wherein the neural network ψ is trained prior to the training of the neural network θ and the neural network η using the total loss, and wherein the neural network ψ is trained using a traditional supervised learning method.

17. The system of claim 16, wherein neural network ψ is fixed during the training of the neural network θ and the neural network η using the total loss.

18. The system of claim 12, wherein the neural network ψ′ is trained using a traditional supervised learning method at a same time as the training of the neural network θ and the neural network η using the total loss.

19. The system of claim 12, wherein the unannotated useful attribute preservation loss is an InfoNCE contrastive learning loss.

20. A non-transitory computer readable storage medium, including instructions stored thereon, which instructions, when read and executed by one or more computer processors, cause the one or more computer processors to perform steps comprising:
executing a machine learning model on at least one computer comprising a processor and a memory;
providing a data transformation module of the machine learning model, wherein the data transformation module accepts a raw dataset as input to a neural network θ, and wherein the neural network θ outputs a transformed dataset;
providing a sensitive attribute suppression module of the machine learning model, wherein the sensitive attribute suppression module accepts the raw dataset as input to a neural network ϕ, accepts the transformed dataset as input to a neural network ϕ′, and calculates, for each attribute of a plurality of annotated sensitive attributes S, a sensitive attribute suppression loss;
providing an annotated useful attribute preservation module of the machine learning model, wherein the annotated useful attribute preservation module accepts the raw dataset as input to a neural network ψ, accepts the transformed dataset as input to a neural network ψ′, and calculates, for each attribute of a plurality of annotated useful attributes U, an annotated useful attribute preservation loss;
providing an unannotated useful attribute preservation module of the machine learning model, wherein the unannotated useful attribute preservation module accepts the transformed dataset and the raw dataset as input to a neural network η, and calculates, for an unannotated useful attribute F, an unannotated useful attribute preservation loss;
combining the sensitive attribute suppression loss, the annotated useful attribute preservation loss, and the unannotated useful attribute preservation loss into a total loss; and
training the neural network θ and the neural network η using the total loss.
